(19) United States
(12) Patent Application Publication
(10) Pub. No.: US 2012/0042956 A1
(43) Pub. Date: Feb. 23, 2012

(54) HANDLE FOR SINGLE LEVER MIXER TAP

(76) Inventor: Eran Ben-Dor, Kochav Yair-Tzur Igal (IL)

(21) Appl. No.: 13/266,539

(22) PCT Filed: Apr. 27, 2010
(86) PCT No.: PCT/IL10/00338

§ 371 Date: Oct. 27, 2011

Related U.S. Application Data
(60) Provisional application No. 61/172,795, filed on Apr. 27, 2009.

(51) Int. Cl. F15D 1/00; F16K 31/60

(52) U.S. Cl. 137/1; 137/603; 74/471 R

(57) ABSTRACT

A handle for a mixer faucet is used to facilitate operating the faucet more easily by using primarily the wrist and forearm muscles. The handle comprises a gripping element (202) and a connector (204) to connect the handle to a mechanism lever of the mixer faucet. The gripping element comprises two sections, both of which lie along an axis substantially perpendicular to the mechanism lever's operating axes. Furthermore, each of the sections is located on an opposite side of the mechanism lever's operating axis. To operate the faucet, the operator's hand holding or touching the handle is aligned in such a way that the longitudinal axis of the hand is substantially continual with the longitudinal axis of the mechanism lever. This allows operating the mixer faucet by using primarily gentle motor skill-type movements.

### FIELD OF THE INVENTION

The present invention relates to mixer faucets. More specifically, the present invention relates to an improved handle for a mixer faucet for easy operation and a method of using same.

### BACKGROUND OF THE INVENTION

Two types of mixer faucets are common today: (a) Mixer faucets with two mechanisms: one for regulating the flow rate of the cold water and one for regulating the flow rate of the hot water. Such a faucet has two operating handles, one for each mechanism, which in most cases are rotating knobs, and (b) Mixer faucets with one mechanism for regulating the flow rates of both the cold and the hot water as well as the water temperature. Such faucets have a single handle movable in two axes for controlling the flow rate and the temperature of the water.

The single handle mixer faucet was invented about 60 years ago and became very common around the world about 30 years ago. Operating the handle, in it's most common form, is carried out by pushing and pulling the handle's tip, i.e., rocking the handle in one axis to control the flow rate and swinging it around the other axis to control the water temperature. Operating such a faucet requires the operator to mainly use gross motor skills.

Over the years numerous inventors tried to modify the faucet and provide simple and easy to use designs, and proposed various designs of single lever mixer faucets, some of which are described herein.

U.S. Pat. No. 6,298,875 relates to single lever mixer taps of two types: One type is operated like a joystick with forward/backward motions regulating flow, while left/right motions regulate temperature. Another type must be pulled up to increase flow and twisted clockwise or counterclockwise to adjust temperature. The writer claims that these compound motions of a single valve are anything but ergonomic and that they may look sleek, but standard dual valves are generally easier to use.

Patent Publication No. WO 2008101326 relates to studies that show conventional hand operated faucets are a source of wasted water and energy and a cross contamination point for the spread of infectious diseases. This patent claims to suggest a simple valve actuator operable by either hip, arm, elbow, foot or knee etc. that is easily installed in association with a cabinet and has an actuator simply constructed, reliable, economical and adjustable to the height of different cabinet toe boards.

DE Patent No. 203156870 describes a control grip for a water mixer tap that has an improved easy to use ergonomic design, applying a cylindrical sleeve that rotates about the water pipe and has an outer grip. The sleeve is moved axially to regulate the water flow rate and is rotated in either direction to adjust the temperature of the outflow.

EP Patent No. 0115032 relates to a mechanical mixer of the type including movable ceramic plates, one compared to the other. One of the relative movements of the plates sets the temperature of the water, while the other one sets the flow rate of the water.

Thus, as noted earlier in the above-mentioned inventions, and in general, faucets available nowadays are disadvantageous for having a structure which requires using gross motor skills during operation. The use of gross motor skills makes it difficult to finely adjust the water flow rate and temperature and leads to the wasting of water.

Some of today's designs enable easy flow rate adjustments but not easy temperature adjustments. Other designs make the new product more complex and/or expensive. Yet other designs solve one problem while causing others, for example, electronic-type faucets which enable water saving by restricting the water flow rate to a preset flow rate may not be convenient to the user upon performing certain tasks.

Thus, none of the faucet designs available today provide an easy to use low cost faucet which enables fine regulation of the water flow rate and temperature with minimal wasting of water.

An aim of the present invention is to provide an improved ergonomic faucet structure. More specifically, a faucet structure operable by using gentle motor skills to enable easy operation and making fine adjustments of the water flow rate and temperature, which in turn may aid in saving water.

### BRIEF SUMMARY OF THE INVENTION

There is thus provided, according to embodiments of the present invention, a handle for a mixer faucet to facilitate operating the faucet more easily by using primarily the wrist and forearm muscles. The handle comprises a gripping element and a connector to connect the handle to a mechanism lever of the mixer faucet. The griping element comprises two sections both of which lie along an axis substantially perpendicular to the mechanism lever's operating axis.

Furthermore, each of the sections are located on an opposite side of the mechanism lever's operating axes, thereby, to operate the faucet, the operator's hand is aligned in such a way that the hand simultaneously holds or touches the sections of the handle. Thus, operating the mixer faucet is done by using one of gross motor skill-type movements and gentle motor skill-type movements.

Furthermore, in accordance with embodiments of the present invention, to operate the faucet, the operator's hand is aligned in such a way that the longitudinal axis of the hand is substantially continual to the longitudinal axis of the mechanism lever. This allows operating the mixer faucet by using one of gross motor skill-type movements and gentle motor skill-type movements.

Furthermore, in accordance with embodiments of the present invention, the gripping element is spaced apart from the connector to enable enveloping the griping element with one hand by wrapping the fingers of the user around the gripping element.

Furthermore, in accordance with embodiments of the present invention, the gripping element extends on both sides of the longitudinal axis of the mechanism lever.

Furthermore, in accordance with embodiments of the present invention, the gripping element is spaced apart from the connector between 5 mm to 100 mm, and preferably between 10 mm to 60 mm to facilitate holding the griping element within the ones hand.

Furthermore, in accordance with embodiments of the present invention, the handle is used for pivoting and rotating a mechanism lever.

Furthermore, in accordance with embodiments of the present invention, the mechanism lever of the mixer faucet is easily pivoted and rotated with one hand by holding or touching the griping element within one hand, thereby aligning the operator's hand so that the hand simultaneously holds or touches said sections of the handle.

Furthermore, in accordance with embodiments of the present invention, the mechanism lever can be at any angle with respect of the floor.

Furthermore, in accordance with embodiments of the present invention, a method for operating the mixer faucet of the present invention comprises the following steps: (a) providing a faucet with the new handle of the present invention connected to the mechanism lever of the faucet, and (b) manipulating the griping element of the handle with one hand thereby aligning the hand of the operator so that the hand is simultaneously holds or touches the sections of the handle.

Furthermore, in accordance with embodiments of the present invention, the gripping element being spaced apart from the connector to enable enveloping the griping element with one hand by wrapping the fingers of the user around the gripping element.

Furthermore, in accordance with embodiments of the present invention, the gripping element extends on both sides of the longitudinal axis of the mechanism lever.

Furthermore, in accordance with embodiments of the present invention, the gripping element is spaced apart from the connector between 5 mm to 100 mm, and preferably between 10 mm to 60 mm to facilitate holding the griping element within the ones hand.

Furthermore, in accordance with embodiments of the present invention, operating the handle comprises using one of gross motor skill-type movements and gentle motor skill-type movements.

### BRIEF DESCRIPTION OF THE DRAWINGS

FIG. 1A (PRIOR ART) is a perspective view of a typical single lever mixer tap with a typical standard handle;

Referring now to FIG. 1B (PRIOR ART) which is an exploded view of the typical single lever mixer tap with a typical standard handle;

FIGS. 1C & 1D illustrate the mechanism lever and the handle rotating about the transverse axis of the mechanism lever;

FIGS. 1E &1F illustrate the radial rotation of mechanism lever and the radial rotation of the handle around the longitudinal axis of the tap's mechanism lever.

FIG. 1G (PRIOR ART) is a side-view illustration of the typical standard single lever mixer tap's handle shown in FIGS. 1A-1F held by the user at close tap position;

FIG. 1H (PRIOR ART) is a side-view illustration of a typical standard single lever mixer tap's handle shown in FIGS. 1A-1G held by the user at open tap position;

FIG. 1I (PRIOR ART) is a top view of the standard single lever mixer tap's handle at its 50% cold water and 50% hot water mix position;

FIG. 1J (PRIOR ART) is a top view of the standard single lever mixer tap's handle at its 0% cold water and 100% hot water mix position;

FIG. 1K (PRIOR ART) is a perspective view of a standard handle installed vertically over the wall;

FIG. 1L (PRIOR ART) illustrates the position of the operator's elbow prior to pulling the standard single lever mixer tap's handle shown in FIG. 1K;

FIG. 1M (PRIOR ART) illustrates the position of operator's elbow after pulling the standard single lever mixer tap's handle shown in FIG. 1K;

FIGS. 1N and 1O (PRIOR ART) are front views of the typical standard single lever mixer tap's handle shown in FIG. 1K at a 50% cold water and 50% hot water mix position and at a 0% cold water and 100% hot water mix position respectively;

FIG. 2A is a perspective view illustration of the new handle in accordance with an embodiment of the present invention;

FIG. 2B is a perspective view illustration of a single lever mixer tap (faucet) with the new handle in accordance with embodiments of the present invention.

FIG. 2C is an exploded view of the single lever mixer tap with the new handle shown in FIG. 2B;

FIG. 2D is a perspective view of the single lever mixer tap of the present invention without the new handle;

FIG. 2E is a perspective view illustration of the single lever mixer tap with the new handle seen in FIG. 2B;

FIG. 2F is a perspective view of the single lever mixer tap without the new handle;

FIG. 2G is a perspective view illustration of a single lever mixer tap with the new handle of FIG. 2B;

FIG. 2H is a front view illustration of the single lever mixer tap with the new handle;

FIG. 3 is a perspective view illustration of single lever mixer tap with another new handle in accordance with embodiments of the present invention;

FIG. 4A is a perspective view illustration of single lever mixer tap with yet another new handle in accordance with embodiments of the present invention;

FIG. 4B is a side-view illustration of new handle illustrated in FIG. 4A held by the user at open tap position;

FIG. 4C is a side-view illustration of new handle illustrated in FIG. 4A held by the user at close tap position;

FIG. 4D is a perspective view illustration of single lever mixer tap with yet another new handle in accordance with embodiments of the present invention;

FIG. 5 is a perspective view illustration of low position single lever mixer tap that is reachable from above;

FIG. 6A is a side view of the new handle illustrated in FIG. 4A at close tap position;

FIG. 6B is a side view of the new handle illustrated in FIG. 4A at open tap position;

FIG. 6C is a side-view illustration of new handle illustrated in FIG. 4A held by the user at close tap position;

FIG. 6D is a side-view illustration of new handle illustrated in FIG. 4A held by the user at open tap position;

FIGS. 6E and 6F are front views of new handle of FIGS. 4A and 4D at 50% cold water and 50% hot water mix position and at 0% cold water and 100% hot water mix position respectively.

### DETAILED DESCRIPTION OF THE INVENTION

As noted earlier, single lever mixer faucets available nowadays require using mainly gross motor skills during operation. This makes it difficult to perform fine movements and fine adjustments to the water flow rate and temperature. In addition, as the adjustments are not easily carried out and require some trial and error procedures, users frequently end up using a stream stronger than needed and thus waste water.

The present invention is of a new ergonomic design of a new handle for a single lever mixer tap. The new design enables the user to operate the faucet by using gentle motor skills and easily perform fine adjustments to the water flow rate and temperature as well as develop motor memory. Motor memory is a form of procedural memory that involves consolidating a specific motor task into memory through repetition. When a movement is repeated over time, a long-term muscle memory is created for that task eventually allowing it to be performed without conscious effort. This process decreases the need for attention and creates maximum efficiency within the motor and memory systems.

Motor memory, regarding fine adjustments, may not be efficiently developed with the standard single lever mixer tap's handle as fine adjustments to the water flow rate and temperature are difficult to be controlled and thus are not repeated the same way over and over again as these standard single lever mixer taps that are available nowadays enable mainly the use of gross motor skills. On the other hand, in case of the improved ergonomic faucet structure of the present invention, motor memory will be developed and will allow the operator to immediately achieve the desired water flow rate and temperature, thereby decreasing waste of water. Thus, there will be no need to dedicate time to long and repetitive attempts at adjustment and water will be saved.

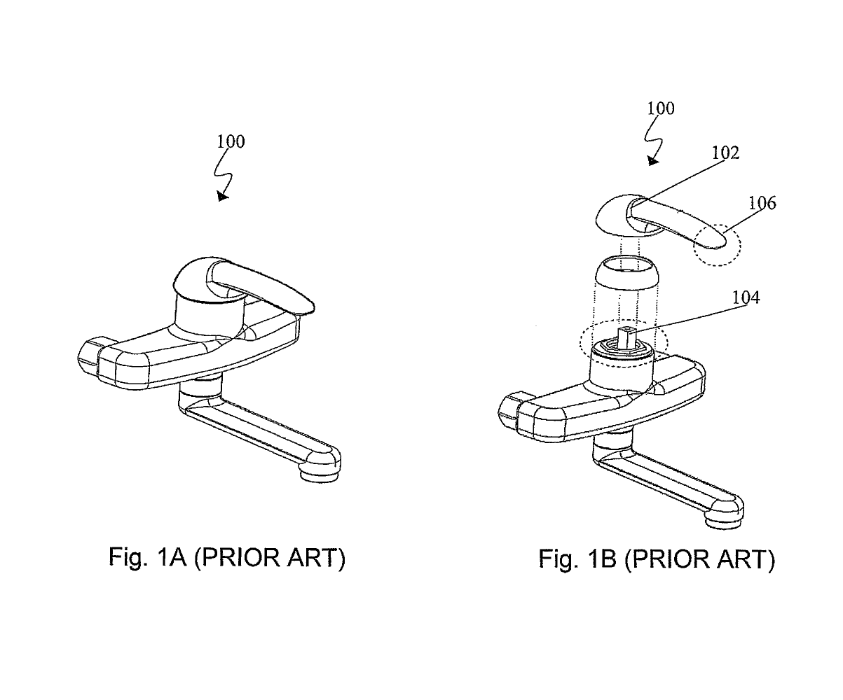

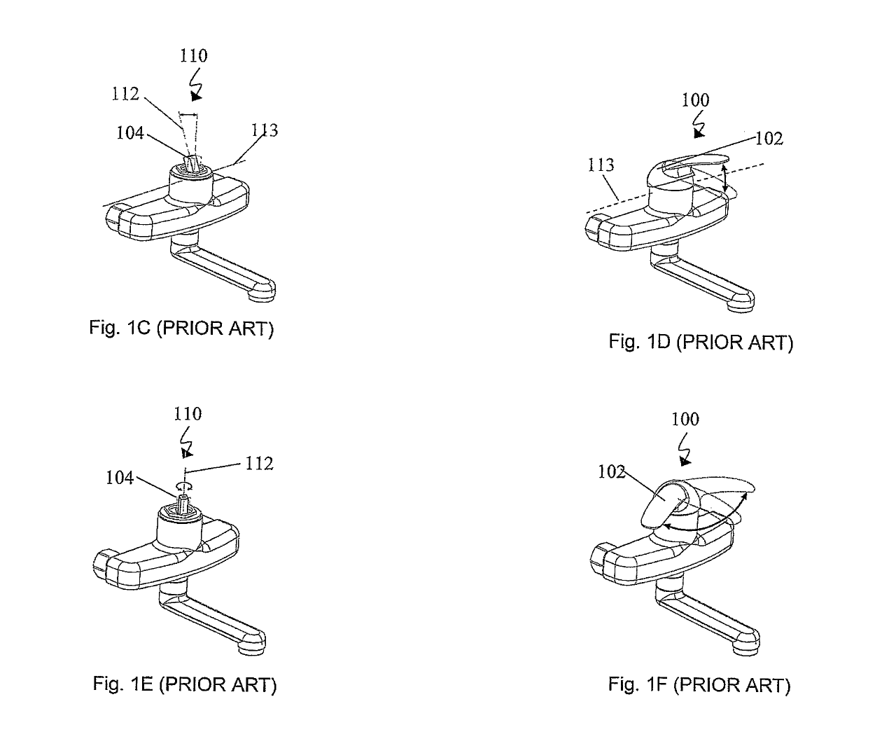

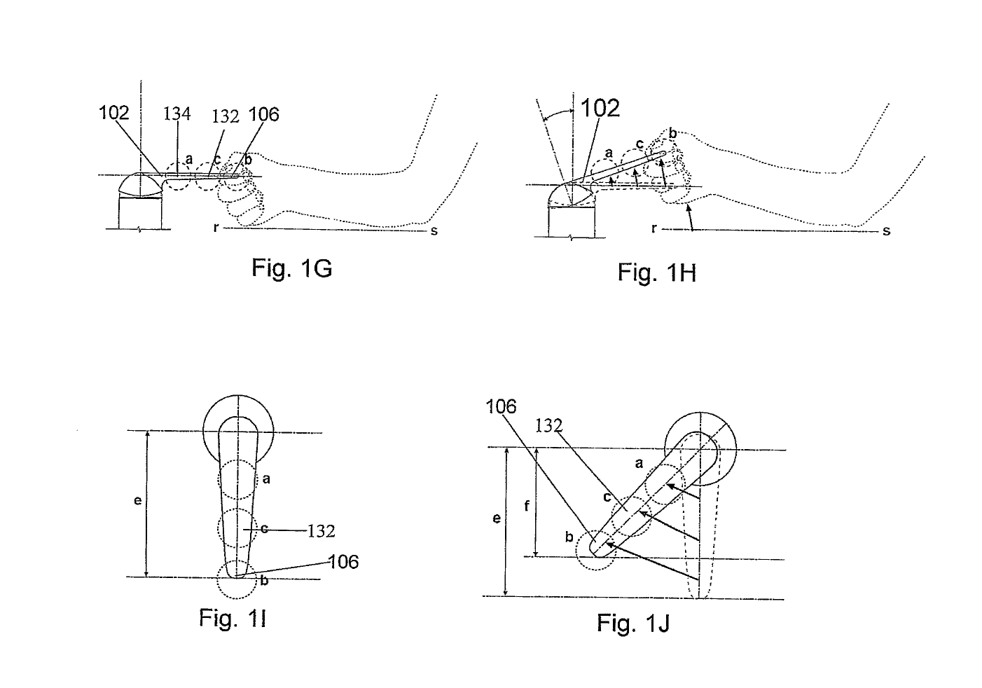

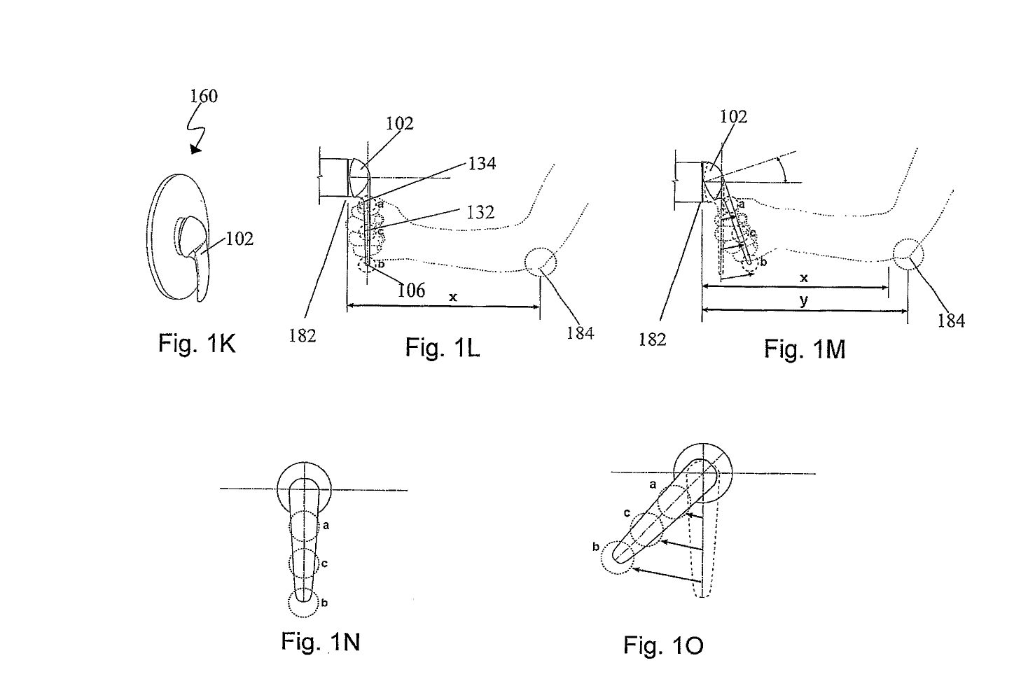

Referring now to FIG. 1A (PRIOR ART) which is a perspective view of a typical single lever mixer tap with a typical standard handle. Such a single lever mixer tap possesses two inlets, a mixing chamber and a single outlet. Thus, hot and cold water enter through first and second inlets into a mixing chamber and exit through a single outlet.

Referring now to FIG. 1B (PRIOR ART) which is an exploded view of the typical single lever mixer tap with a typical standard handle. As seen in FIG. 1B, the tap mechanism lever 104 is vertically installed.

In common single lever mixer taps seen in FIGS. 1A-1F, the operating lever 102 (hereinafter referred to as “handle”) is movable about an axis that is perpendicular 113 to the axis 112 of the tap mechanism lever 104 (see FIGS. 1B and 1C) to allow regulating the water flow rate. FIGS. 1C & 1D illustrate the tap mechanism lever 104 pivoting and handle 102 rotating around axis 113

FIGS. 1E & 1F illustrate the tap mechanism lever 104 radial rotation and handle 102 rotation about axis 112 to allow controlling the temperature of the water.

Thus, typical single lever mixer taps are designed in such a way that by moving the handle's tip 106 upwards or downwards, handle 102 is rotating around axis 113 and either increases or decreases the water flow rate. Similarly, by moving the handle's tip 106 towards the right/left direction, handle 102 rotates around the tap mechanism vertical axis 112 and the relative amount of cold/hot water is adjusted. Finally, moving the handle tip 106 all the way down, stops the water flow.

As noted earlier, operating the standard lever handle 102 of the standard single lever mixer taps requires the user to perform gross motor movements using the elbow and the shoulder joints which makes it difficult to perform delicate and precise adjustments of the water flow rate and temperature.

To emphasize the advantages of the improved ergonomic faucet structure of the present invention over the typical standard single lever mixer tap, the standard operating procedure of the typical standard single lever mixer tap is presented herein.

Referring now to FIG. 1G (PRIOR ART) which is a side-view illustration of the typical standard single lever mixer tap's handle shown in FIGS. 1A-1F held by the user at close tap position; Operating handle 102 involves utilizing mainly the arm and the chest muscles to apply the force needed to move handle 102. Operating handle 102 may be performed either by holding the tip 106, holding the handle at any other section along handle 102 such as, for instance, section 132 or by wrapping the handle with the fingers in a closed first form, i.e., holding handle 102 at sections 106, 132, and 134. Regardless of the way handle 102 is held, the operator uses either the arm muscles, chest muscles or both the arm and chest muscles to move handle 102, i.e., to move sections 106, 132 and 134 of the handle upwards in order to produce water flow.

Referring now to FIG. 1H (PRIOR ART) which is a side-view illustration of a typical standard single lever mixer tap's handle shown in FIGS. 1A-1G held by the user at open tap position. Seen in FIG. 1H, moving handle 102 upwards to its open tap position involves bending either the elbow or the shoulder, or both.

It should be noted that movements of the elbow and/or the shoulder joints are gross motor skill-type movements which make fine adjustments of the handle position difficult to accomplish.

As seen in FIG. 1H, during operation, the elbow stays close to the horizontal “r-s” line while the palm is drawn away from it.

It should be noted that a reverse action, i.e., the moving of handle 102 downwards to its closed tap position requires the same joints usage, thereby requiring gross motor skill-type movements as well.

Similarly, same principles apply to the type of operations illustrated in FIG. 11 which is a top view of handle 102 shown in FIG. 1G at its 50% cold water and 50% hot water mix position and in FIG. 1J which is a top view of handle 102 shown in FIG. 1G at its 0% cold water and 100% hot water mix position. Here also, moving handle 102 into the various possible positions requires the participation of the shoulder joint and refers to gross motor skills-type movements which make fine adjustments of the handle position difficult to accomplish.

Referring now to FIG. 1K (PRIOR ART) which is a perspective view of a standard handle installed vertically 160 over the wall.

Referring now to FIGS. 1L and 1M (PRIOR ART) which are side-view illustrations of the typical standard single lever mixer tap's handle shown in FIG. 1K held by the user at closed tap position and at open tap position respectively. While operating handle 102, the user may hold tip 106, the handle, at any other section along handle 102 such as, for instance, section 132 or by wrapping the fingers around the handle in a closed first form, i.e., holding handle 102 at sections 106, 132, and 134. Regardless of the way handle 102 is held, sections 106, 132 and 134 of the handle have to be pulled towards the operator in order to start the water flow. Therefore, the operator has to use the above-mentioned joints to move handle 102, i.e., to move sections 106, 132 and 134 of the handle towards the operator in order to start the water flow.

FIG. 1L illustrates the position of elbow 184 prior to pulling handle 102, at a distance “x” from point 182. FIG. 1M illustrates the position of elbow 184 after pulling handle 102, at a distance “y” from point 182. As seen, the distance between point 182 and elbow 184 increases when pulling handle 102, thus, as noted above, pulling handle 102 requires the participation of the shoulder joint.

Referring now to FIGS. 1N and 1O (PRIOR ART) which are front views of the typical standard single lever mixer tap's handle shown in FIG. 1K at a 50% cold water and 50% hot water mix position and at a 0% cold water and 100% hot water mix position respectively. Here also moving handle 102 to the various possible positions requires the participation of the shoulder joint and refers to gross motor skills-type movements which make fine adjustments of the handle position difficult to accomplish. It should be noted that the use of gross motor movements may cause an initial stronger or weaker flow rate and/or warmer or colder water than desired. Furthermore, as gross motor skill-type movements are involved with operating the faucet, performing delicate and precise adjustments may sometimes result in a series of overshooting and undershooting trials, thereby possibly causing waste of water. In some cases, the user may get the desired water flow rate and temperature but in others, the user may compromise on the achieved water flow rate and temperature after some time, even if not exactly as desired.

It should be noted that a flow rate lower than desired may prevent the user from performing tasks such as hand washing, showering and the like, in a comfortable and efficient manner. A flow rate stronger than desired, on the other hand, may enable the user to perform his/her tasks in an efficient and comfortable manner but at the same time may cause wasting of water.

Thus, the improved faucet design, in accordance with embodiments of the present invention, overcomes the above-mentioned drawbacks of standard single lever mixer taps. The improved faucet design provides the user with a better and easier control over standard single lever mixer taps and enables him to perform more delicate and precise adjustments to the water flow and temperature.

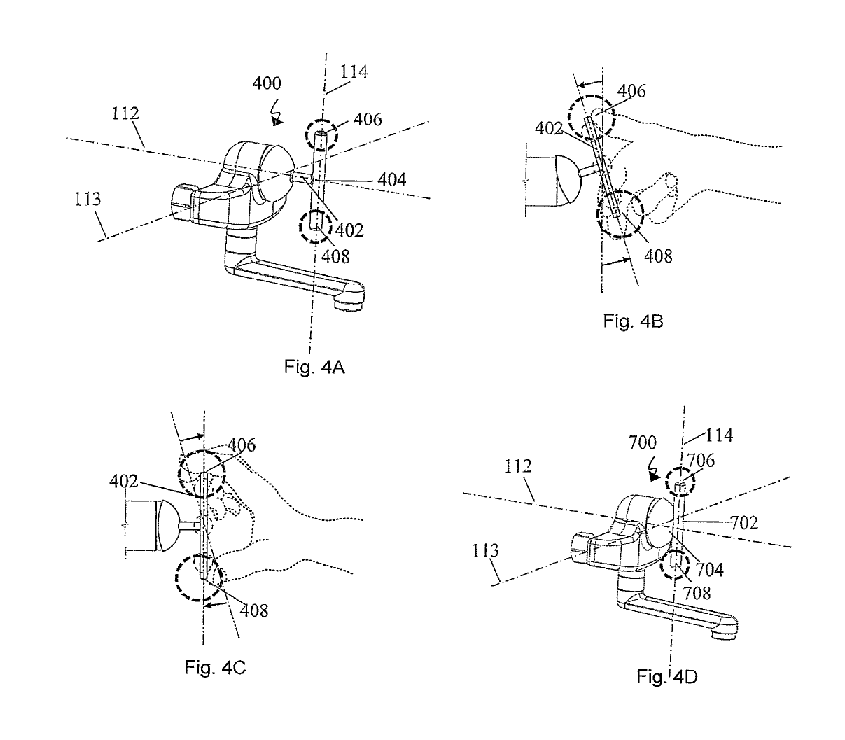

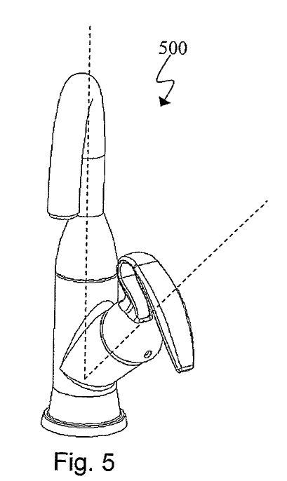

As noted earlier, the single lever mixer tap with a new handle of the present invention includes a single handle, and can be used in standard valve mechanism used in common faucets today. The key point, however, in the present invention is the new handle's design with respect of the tap mechanism structure that is distinguished in the present invention. To be specific, in accordance with the present invention, as exemplified in FIG. 4A, 4D, the tap's new operating handle is designed in a way that it extends on both sides of mechanism operating axes 112 and 113 and at least two sections of the handle, for instance: 406, 408, can be held or touched by the operator's hand simultaneously when both sections are located along an axis 114 that is more or less perpendicular to both tap mechanism operating axes 112 and 113, when each section 406, 408 is located at an opposite side of both mechanism operating axes 112 and 113. While operated and moved, both around the mechanism 112 and/or 113 axes, the two sections 406 and 408, moves simultaneously in opposite directions.

It will be easier to operate the handle when handle's axis 114 is substantially perpendicular to both mechanism operating axes 112 and 113.

When using the typical standard handle of a single lever mixer tap, the force delivered by the operator's hand is applied, in general, to a single certain section of the handle and applied, in general, to a single certain direction.

When using the new handle, the force delivered by the operator's hand and aimed at the handle, is divided to the two, distant and distinguished sections mentioned above. Spreading the force to different sections and applying it in two opposite direction at the same time makes it easier to operate the handle as the task and the effort is divided between two different sections of the operator's hand.

Such a design enables the operator to use gentle motor skill-type movements while operating the faucet, or more specifically, to operate the faucet primarily with his/her wrist joint and forearm muscles, thus, to perform fine adjustments to the water flow rate and temperature easily.

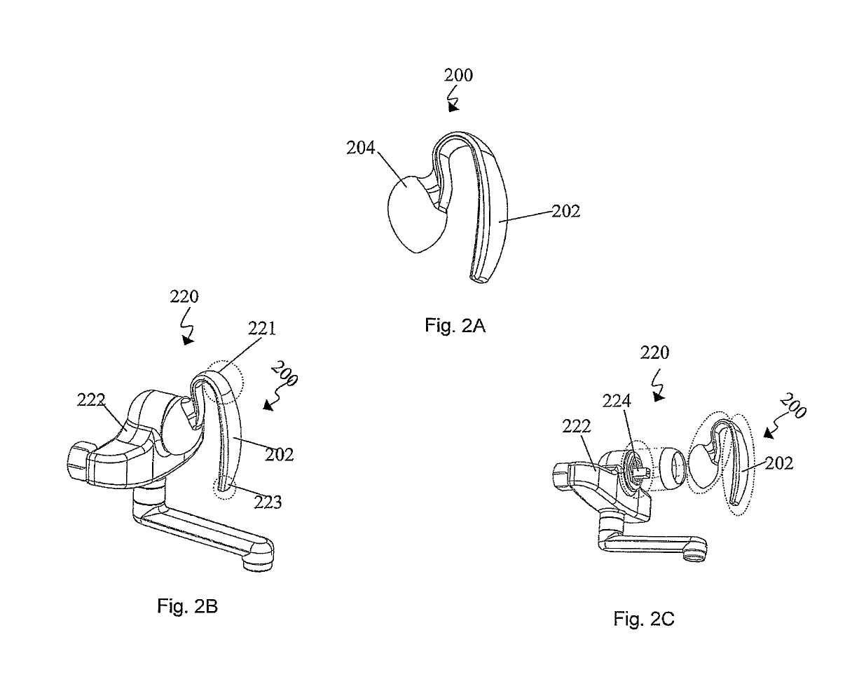

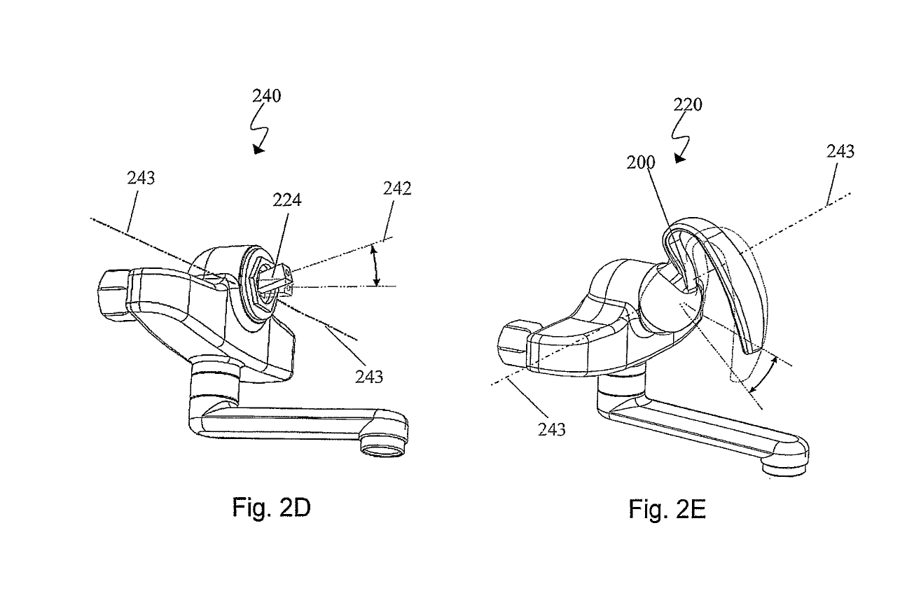

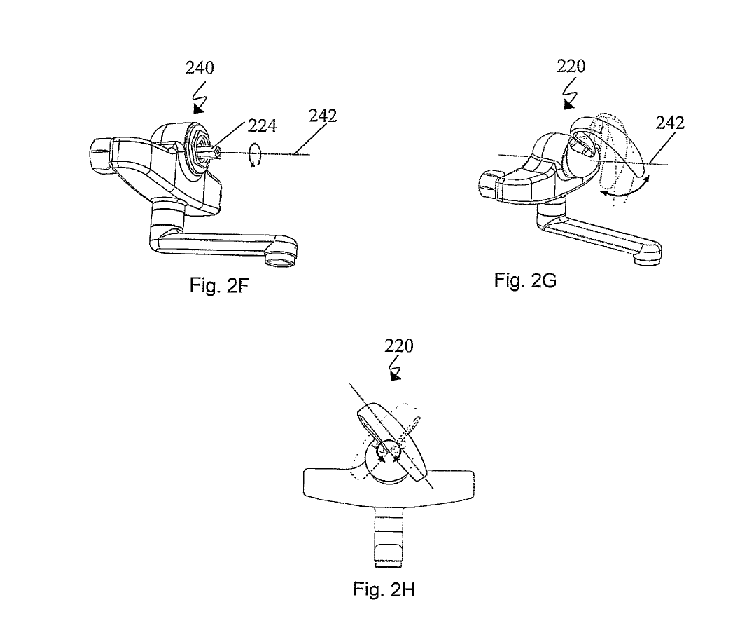

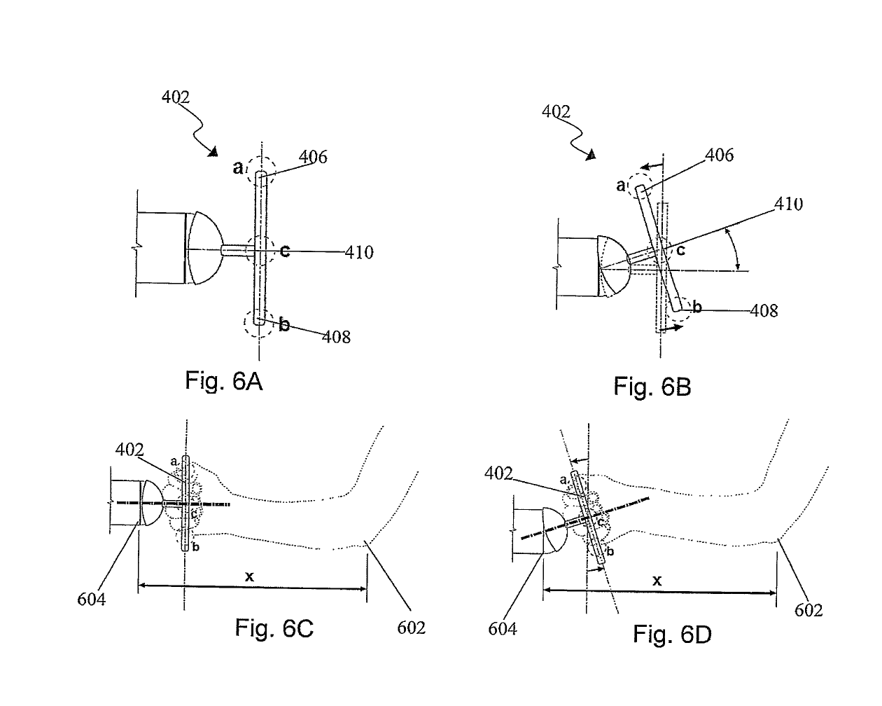

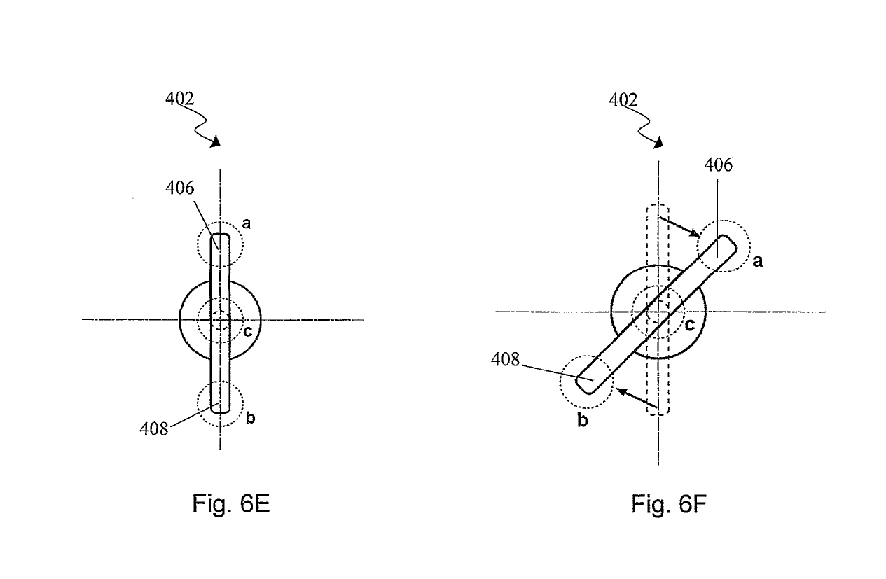

Referring now to FIG. 2A which is a perspective view illustration of the new handle in accordance with embodiments of the present invention; seen in FIG. 2A, new handle 200 comprises two basic elements: gripping element 202 which can be gripped or otherwise held or touched by the user, and connector 204 which connects gripping element 202 to the tap mechanism lever. In operation, holding element 202 may be held in any convenient way. The new handle can be designed to enable operating the tap when the hand is fully gripping the handle, as illustrated in FIG. 6C-6D or in a way that doesn't enable full gripping of the handle but enables the operator to hold and/or touch and move the two sections of the handle, as described above, simultaneously, in opposite directions, using one hand, as illustrated for instance in FIG. 4B, 4C: the index finger is pulling one section of the handle while the thumb is pushing the other section using the wrist joint and forearm muscles.

Referring now to FIG. 2B which is a perspective view illustration of a single lever mixer tap with the new handle 220 in accordance with embodiments of the present invention; FIG. 2B illustrates the arrangement of new handle 200 and tap 222.

FIG. 2C is an exploded view of the single lever mixer tap with the new handle 220 shown in FIG. 2B. Seen in FIG. 2C, the mechanism lever 224 is perpendicular with respect to gripping element 202 of new handle 200. In addition, mechanism lever 224 and gripping element 202 are arranged in such a way so as to enable the user to either wrap gripping element 202 with his/her fingers or to hold the portion of gripping element 202 Thus, operating handle 200, i.e., adjusting the flow rate and temperature of the water mainly involves using the wrist joint and twisting the forearm along its longitudinal axis.

In accordance with some embodiments of the present invention, mechanism lever 224 may be substantially parallel or at any angle with respect of the floor.

It should be understood that the above-mentioned wrist joint and forearm movements are gentle motor skill-type movements of the hand that enable the operator to perform fine tuning of the water flow rate and temperature.

It should be further noted that the unique design of new handle 200 enables the user to operate the tap by holding/touching various sections along new handle 200 by body parts other than his/her arm. For instance, new handle 200 may be held and used in the same way as the standard handle (shown in FIGS. 1A, B, D and F) is held and used, i.e., (a) the user may hold/touch tip 223 of new handle 200 and simply move it up/down and left/right, (b) the user may position his/her forearm on gripping element 202 and may fully operate new handle 200 without the need to hold it with his/her palm, (c) The user may use other parts of his/her body such as for instance the elbow, chin or knee to operate new handle 200 by simply pushing either tip 223 or top section 221 of the handle.

Thus, in accordance with embodiments of the present invention, the single lever mixer tap with new handle 220 of the present invention is advantageous as its distinguished design enables the user to continue using the tap in the same way he/her is used to, and at the same time, enables him/her to enjoy the additional ergonomic qualities when desired and achieve easier and more comfortable control of the tap.

Referring now to FIG. 2D which is a perspective view of the single lever mixer tap 240 without the new handle 200. Seen in FIG. 2D, mechanism lever 224 is pivoting about axis 243.

Referring now to FIG. 2E which is a perspective view illustration of the single lever mixer tap with new handle 220 seen in FIG. 2B. FIG. 2E illustrates the movements of new handle 200 around axis 243. Such rotations allow controlling the water flow.

Referring now to FIG. 2F which is a perspective view of the single lever mixer tap 240 without the new handle 200. Seen in FIG. 2F is an angular rotation of mechanism lever 224 about axis 242.

Referring now to FIG. 2G which is a perspective view illustration of single lever mixer tap with new handle 220 seen in FIG. 2B; FIG. 2G illustrates the angular rotation of new handle 200 about axis 242. Such angular movement allows controlling the water temperature.

Referring now to FIG. 2H which is a front view illustration of single lever mixer tap with new handle 220; Seen in FIG. 2H is the angular rotation of new handle 200.

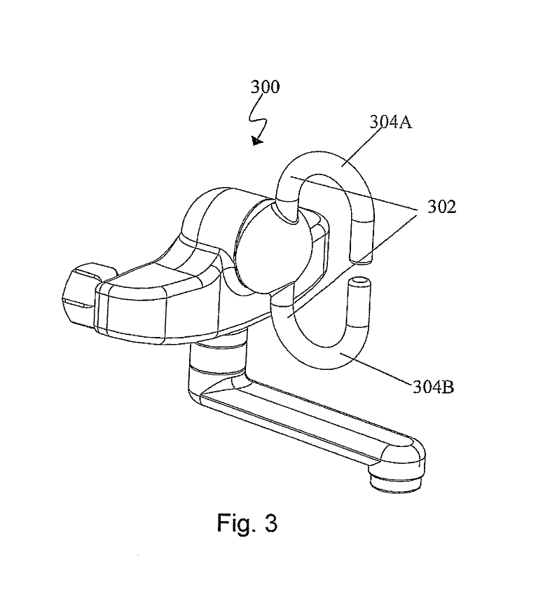

Referring now to FIG. 3 which is a perspective view illustration of the single lever mixer tap with another new handle 300 in accordance with embodiments of the present invention; Seen in FIG. 3, the gripping element handle 302 comprises two parts, upper part 304A and lower part 304B. As seen in FIG. 3, upper part 304A and lower part 304B of new handle 302 are assembled in such a way as to enable the practical use as described above, namely, the user may hold or touch new handle 302 with his/her hand at the two sections as described before, at the same time and move them simultaneously in opposite directions.

Referring now to FIG. 4A which is a perspective view illustration of single lever mixer tap with yet another new handle 400 in accordance with embodiments of the present invention; Seen in FIG. 4A, handle 402 enables the user to hold or touch new handle 402 with his/her hand at two sections (406, 408) of the handle at the same time and move these sections simultaneously in opposite directions.

The operating procedure of the single lever mixer tap with the new handle in accordance with embodiments of the present invention is presented herein.

A brief overview of basic movements of the wrist and forearm are given herein for better understanding of the efficiency of the new handle design.

When the wrist tilts, i.e., radially deviates upwards, the thumb draws closer to the lateral area of the forearm. Similarly, when the wrist tilts downwards, the thumb draws away from the lateral area of the forearm. In medical terms this is called: “ulnar deviation of the wrist”. The neutral position of the wrist exists when a line drawn along the top of the forearm is in a straight line with the top surface of the index finger.

The wrist can also be bended back (dorsiflexion of the wrist) when the back side of the hand is drawn closer to the forearm. When the wrist is bended foreword (palmar flexion of the wrist) the palm is drawn closer to the forearm.

The forearm movements that are relevant to the present invention are pronation and supination. Pronation is when the forearm rotates clockwise so that the palm faces downwards, and supination is when the forearm rotates counterclockwise so that the palm faces upwards.

Referring now to FIG. 5 which is a perspective view illustration of low position single lever mixer tap 500 which is reachable from above; in this case, the mechanism lever of the tap is at a certain angle with respect to the floor and is not parallel to it.

Referring now to FIG. 6A which is a side view of the new handle 402 illustrated in FIG. 4 at close tap position. It should be noted that new handle 402 as well as new handle 200 and new handle 302 may be mounted on a single lever mixer tap, on surfaces such as for instance a wall surface, etc.

Referring now to FIG. 6B which is a side view of the new handle 402 illustrated in FIG. 4 at open tap position. Seen in FIG. 6B, when the handle position is changed to the open tap position, the top tip 406 of the handle is drawn away from the operator while the bottom tip 408 gets closer to the operator.

In a reverse action, i.e., the moving of handle 402 to its closed tap position, the top tip 406 and the bottom tip 408 of the handle return to their original positions. Such movements of the handle match the natural wrist movements, i.e., tilting away from/towards the lateral area of the forearm as illustrated in FIG. 4B 6C and 6D, and/or bending back the wrist (dorsiflexion of the wrist) as illustrated in FIG. 4C. Tilting or bending the wrist is performed by forearm muscles and is carried out by gentle motor skill-type movements that enable better control of small movements and therefore enable the operator to perform fine adjustments to the water flow rate and temperature.

Tilting and/or bending the wrist involves in shortening one group of muscles in the forearm, and lengthening a second group of muscles. While tilting and/or bending the wrist to the opposite direction, the two groups of muscles exchange functions respectively. These two groups of muscles works simultaneously in opposite directions, wherein the second group supports and balances the first group and helps the operator control the speed and accuracy of the movement. Fast uncontrollable movements that can occur due to the operator's attempt to overcome friction in the tap's mechanism, are balanced and moderated by the two coordinated groups of muscles that work simultaneously and support the hand from undesired large and/or fast movements. Furthermore: gripping the handle with the hand is preferable than other kinds of holding/touching the handle as when the hand is wrapped around the handle, the hand is very stable. When the handle is operated that way, two sections of the hand are pushing the handle in two opposite directions, while at the same time, two opposite sections to the mentioned sections of the hand, are supporting the handle opposite to the movement direction, preventing the handle from fast, long uncontrollable movements that can occur when trying to overcome the tap's mechanism friction.

It should be noted that such a complex-type operation can not, practically, take place when operating the standard single lever mixer tap as when trying to perform fine adjustments to the handle, using gross motor skill-type movements, no body-part or muscle-group can efficiently work opposite to the movement direction to balance it and the most influencing counter force to this movement is the tap's mechanism friction which is unstable, unpredictable and uncontrollable. Seen in FIG. 4D, the new handle can be designed in a way that does not enable full gripping of the handle but still enables to operate the handle according to the principles of the present invention by holding and operating the new handle in the same way described in FIG. 4B, 4C.

Seen in FIGS. 6C and 6D, the distance between point 604 and elbow 602 remains unchanged while operating handle 402; this is since operation of handle 402 does not require moving the arm but only tilting the wrist by using the forearm muscles.

Referring now to FIGS. 6E and 6F which are front views of new handle 402 shown in FIGS. 4A and 4D at 50% cold water and 50% hot water mix position and at 0% cold water and 100% hot water mix position respectively; When moving handle 402 from one position to another, the top tip 406 of handle 402 is moving to the right while the bottom tip 408 is moving to the left.

Referring now to FIGS. 6C, 6D, 6E, 6F, such an operation is carried out for adjusting the water flow rate and temperature by using gentle motor skill-type movements (such movements resemble the forearm pronation and supination-type movements as well as wrist tilting and/or bending). Thus, in accordance with embodiments of the present invention, two complex movements of wrist tilting and/or bending and forearm pronation and supination are involved in operating the single lever mixer tap with the new handle. It should be noted that the single lever mixer tap with a new handle of the present invention includes a single handle and can fit a standard valve mechanism that is used in common faucets today. Thus, there is no need to design and produce additional or new mechanisms but only rearrange the faucet's elements and reshape the control handle.

It should be noted that in accordance with embodiments of the present invention, various designs of the new handle may be applied. More specifically, handles made of various materials such as, for instance, polymers, metals, composites etc., as well as handles of various shapes, thicknesses, curvatures, and textures may be applied according to the present invention as long as the practical use described above is enabled. For instance, the handle may be designed to have its top section 221 (see FIG. 2B) curved to fit the thumb tip of the user. Similarly, gripping element 202 may be designed with a textured surface to avoid problems of slipping.

It should be further noted that the single lever mixer tap and the new handle of the present invention may be sold either as a single unit or as separate replacement parts. In addition, the new handle may be used in plumbing units other than a single lever mixer tap. More specifically, the new handle may be used in any plumbing units that require the user to control the combination of water flow rate and temperature such as, for instance, in shower walls or low positioned taps that the user reaches from above, bathtub taps, kitchen sinks etc. Also, the new handle may be used for regulating the flow rate as well as other physical properties of water, other liquids, fluids or solids.

It should be noted that some of the available faucets nowadays which consist a single handle and require a movement in a single axis enable the user to operate the faucet with gentle motor skill-type movements and easily perform fine adjustments. Based on that, one would think that a mixer-type faucet that is operable by using gentle motor skill-type movements may require using two different handles. This is not quite the case as the improved ergonomic faucet structure of the present invention enables a complex movement in two axes: up/down for flow strength and left/right for temperature adjustments by a single handle and by using gentle motor skill-type movements.

The tap mechanism operation requires a complex movement in two axes: up/down for flow strength and left/right for temperature adjustments.

In accordance with some embodiments of the present invention, the new handle may comprise a plurality of parts.

In accordance with some embodiments of the present invention, the new handle is meant to be used with every kind of mechanism that is operated according to the same principles as the mechanism described in this document and to be more specific: all kinds of mechanisms that are operated in a combination of two different axes, that can be controlled using the new handle with the same overall principles described in this document.

The new handle can be used to control other systems, rather than plumbing, that requires the adjustment of two different aspects of amount and/or flow rate, using a single handle.

1. A handle for a single lever mixer faucet to facilitate operating said faucet more easily by using primarily the wrist and forearm muscles,
characterized in that the handle comprises a gripping element and a connector to connect said handle to a mechanism lever of the mixer faucet,
said griping element comprising two sections both of which lie along an axis substantially perpendicular to the longitudinal axis of the mechanism lever, each of said sections being located on an opposite side of the longitudinal axis of the mechanism lever, whereby the two sections of the griping element move in opposite directions from one another when operating the faucet.

2. A handle according to claim 1, wherein the griping element is of sufficient length so that both sections of the gripping member can be held with one hand.

3. A handle according to claim 1, whereby, when operating said faucet, the operator's hand holding said griping sections of said handle aligns in such a way that the longitudinal axis of the hand is substantially continual with the longitudinal axis of the mechanism lever, thus, operating said mixer faucet by using primarily gentle motor skill-type movements.

4. A handle according to claims 1 to 3, wherein the gripping element comprises a curved end terminating with the connector.

5. A handle according to claims 1 to 4, wherein said gripping element is spaced apart from the connector to enable holding the griping element with one hand by wrapping the fingers of the user around said gripping element.

6. A handle according to claim 5, wherein the gripping element is spaced apart from the connector between 5 mm to 100 mm, and preferably between 10 mm to 60 mm, to facilitate holding said griping element.

7. A handle according to claims 1 to 6, wherein the length of the griping element is between 8 cm and 25 cm.

8. A single lever mixer faucet that is easily pivoted and rotated with one hand characterized in that the faucet has a handle as in any one of claims 1 to 7 connected to a mechanism lever of said faucet, whereby the faucet is operated by moving the griping element with one hand, thereby pivoting the two sections of the griping element in opposite directions from one another.

9. A single lever mixer faucet in accordance with claim 8, wherein the handle is substantially perpendicular to one of the operating axis 113 of the lever mechanism.

10. A single lever mixer faucet according to claims 8 and 9, wherein said mechanism lever can be at any angle with respect of the floor.

11. A single lever mixer faucet according to claims 8 to 10, suitable for homeowners such as for a kitchen or bathroom.

12. A method for operating a single lever mixer faucet comprising a handle according to claims 1 to 7, comprising manipulating said gripping element of said handle with one hand whereby the two sections of the griping element move in opposite directions from one another when operating the faucet.

13. A method for operating a single lever mixer faucet comprising a handle according to claim 12, wherein the longitudinal axis of the hand holding the handle is substantially continual with the longitudinal axis of the mechanism lever, thus, operating said mixer faucet by using primarily gentle motor skill-type movements.

14. A method according to claims 12 and 13, wherein the gripping element is spaced apart from the connector between 5 mm to 100 mm, and preferably between 10 mm to 60 mm to facilitate holding said griping element within the ones hand.

15. A method as in any one of claims 12 to 14, wherein operating said handle comprises primarily gentle motor skill-type movements.
